(19) United States
(12) Patent Application Publication
(10) Pub. No.: US 2008/0253361 A1
(43) Pub. Date: Oct. 16, 2008

(54) Receiving party based web-to-phone communication

(75) Inventors: John Chung-I Hsu, Cerritos, CA (US); Ten-Lee Hwang, Taipei (TW)

Correspondence Address: BACON & THOMAS, PLLC, 625 SLATERS LANE, FOURTH FLOOR, ALEXANDRIA, VA, 22314-1176, US

(73) Assignee: CRYSTAL BIZVIEW, LLC, Cerritos, CA (US)

(21) Appl. No.: 12/078,903

(22) Filed: Apr. 8, 2008

Related U.S. Application Data
(60) Provisional application No. 60/911,793, filed on Apr. 13, 2007.

(51) Int. Cl. H04L 12/66

(52) U.S. Cl. 370/352

(57) ABSTRACT

A method for communicating in a communication system, said communication system comprising a network terminal of a network user, a server of a telecommunication company, and a telephone of a receiver, the method comprises the steps of: (A) the receiver registering an encoded object from the telecommunication company, the encoded object is associated with a telephone number; (B) the receiver distributing the encoded object for the network user to identify, (C) the network user clicking the encoded object; (D) in response to the network user's clicking, the server connecting the network terminal to the telephone which uses the telephone number for a communication connection; and (E) the telecommunication company collecting service fee from the receiver. The method can also be applied to Internet-based communication companies where the encoded object can be its customer membership for identification.

### CROSS-REFERENCE TO RELATED APPLICATION

This application claims the benefit of U.S. Provisional Patent Application Ser. No. 60/911,793 filed on Apr. 13, 2007, and the subject matter thereof is hereby incorporated herein by reference thereto.

### FIELD OF THE INVENTION

This application relates to direct voice communication connections between Internet and public telephone communication systems.

### BACKGROUND OF THE INVENTION

The Internet telephony services have been booming in modern years, which offer newer and low-cost communication options to general public. Although, Internet telephony attracts large amount of customers by its virtually free services, it also significantly shrinks overall revenue from traditional public switch telephone network operators. However, the overall quality, convenience, and practicality of Internet telephony are still lacking to become the mainstream telephony services.

Most often you find Internet telephony service providers offer community-based PC-to-PC free services, which required both calling and receiving parties to register with the same service provider and installed the same proprietary software in advance. Many Internet telephony service providers offer their subscribers PC-to-Phone and Phone-to-PC services. These services are fee-based and usually in pre-paid. They still require advanced registration and/or installation of proprietary software. A related patent (U.S. Pat. No. 6,707,811, Internet telephony for ecommerce) also describes methods and systems to offer “pre-registered” end-users (calling party) to make voice calls between various terminals, particularly for call centers. Another familiar service under a generic term of ‘Click-to-Call’ or ‘Click-to-Talk’, which require network users to enter their private telephone numbers on a web based interface to receive a call back at the telephone number entered, which is really the old fashion phone-to-phone voice service.

Today, most businesses using Internet for commercial or any other purposes are typically lacking interactive voice communication features, including call centers, on their web presences. Unfortunately, most websites and web pages can only list their phone numbers for customers to call. Without present invention, offering live interactive voice support on the Internet will require live operators to stand by computers, which is too much of a burden for majority companies to provide such on-net supports.

To close such a gap and improve today's Internet communication, we need a direct, open (non-community based), and convenient voice service, which could drastically improve the friendliness and usefulness of overall Internet services. This service should also provide exceptional privacy protection and benefits to both callers and receivers.

### SUMMARY OF THE INVENTION

The main objective of the invention is to provide instant VoIP connection of web-initiated call to traditional public telephone networks with one simple click on special registered encoded object that corresponds to the receiving party. The encoded object can be represented by any forms of Internet media and placed on any web presences or available network access. Its purpose is to offer Internet telephony and traditional telephone convergence services, which provides an integrated, open, and convenient telephony service of high quality to all general Internet users.

The present invention offers new and better benefits to all entities involved. Callers can continue making free Internet or mobile voice calls without the need to pre-install proprietary software or pre-registering with service provider; Receivers, without any capital investment, can offer and receive interactive voice—from callers. All Internet service providers can easily offer such voice services to their website customers. Traditional telephone operators can increase their voice business and generate new revenue streams.

In accordance with one aspect of the invention, the present invention consists of a method for communicating in a communication system, said communication system comprising a network terminal of a network user, a server of a telecommunication company, and a telephone of a receiver, the method comprises the steps of: (A) the receiver registering an encoded object from the telecommunication company, the encoded object is associated with a telephone number; (B) the receiver distributing the encoded object for the network user to identify; (C) the network user clicking the encoded object; (D) in response to the network user's clicking, the server connecting the network terminal to the telephone which uses the telephone number for a communication connection; and (E) the telecommunication company will collect service fee from the receiver.

In accordance with another aspect of the invention, the present invention can serve an Internet Telephony Company and include the same voice services for its members. Allow members to use their memberships as encoded objects and distribute them for network users to identify. Triggering by the membership account will initiate a voice call link to the receiver and receiver will pay for the service fee incurred.

The detailed embodiments, advantages and spirit of the present invention can be further understood by way of the following detailed descriptions and appended drawings.

### BRIEF DESCRIPTION OF DRAWINGS

The foregoing and advantages of the invention will be appreciated more fully from the following further description thereof with reference to the accompanying drawings wherein:

FIG. 1 is a high-level diagram showing parties and entities in accordance with one embodiment of the present invention.

FIG. 2 is a flow diagram of an exemplary operation performed in accordance with one embodiment of the present invention.

FIG. 3 is a high-level diagram showing parties and entities in accordance with one embodiment of the present invention.

FIG. 4 is a flow diagram of an exemplary operation performed in accordance with one embodiment of the present invention.

### DETAILED DESCRIPTION OF SPECIFIC EMBODIMENTS

In the following description, for the purpose of explanation, numerous specific details are set forth in order to provide a thorough understanding of the invention. The description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. Thus, the present invention is not intended to be limited to the embodiments shown.

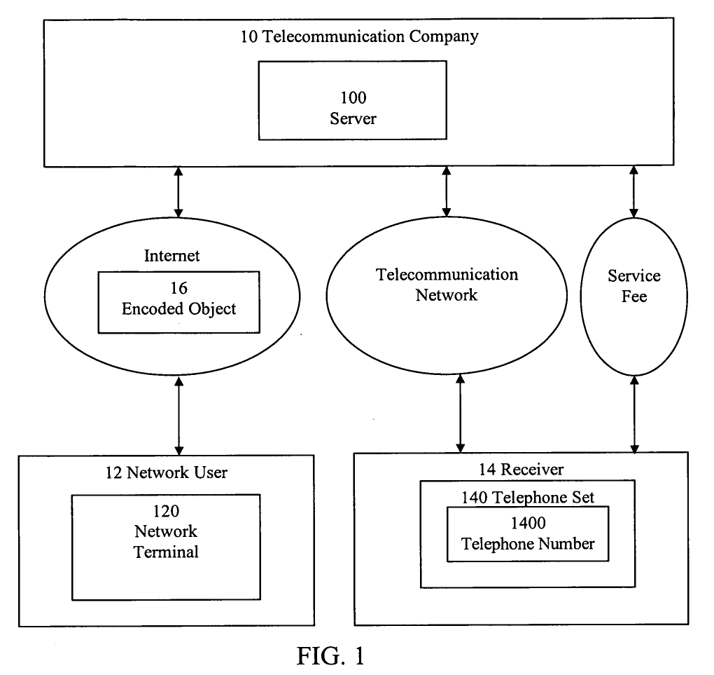

FIG. 1 is a high-level diagram showing parties and entities in accordance with one embodiment of the present invention.

Network User 12 use Network Terminal 120 to make call where as Network Terminal 120 refers to desktop computer, laptop computer, mobile and smart phone, PDA, or similar devices that has ability to access Internet or mobile network with internal or external devices that can provide display, click, and voice functions. Display function refers to devices, such as monitors or handset screens, which can be browsed and display information. Click function refers to devices, such as keypad, mouse or touch panel, which allow Network User 12 to click on displayed information. Voice function refers to devices including speaker and microphone that collects and transmits voice.

Receiver 14 uses Telephone Set 140 that is associated with Telephone Number 1400 to answer a call. Telephone Set 140 refers to fixed, landline, mobile, cellular, cordless, or Internet (VoIP) telephone set.

Telecommunication Company 10 owns Server 100. Telecommunication Company 10 refers to companies that offer communication services and are regulated by the Federal Communication Committee or the like in its operating area. Server 100 and Network Terminal 120 are connected via Internet or mobile network. The connection of a Server 100 and Telephone Set 140, which is associated with a Telephone Number 1400, is via a telecommunication network. Telecommunication network refers to public telecommunication networks, including public switched telephone network (PSTN), public land mobile network (PLMN), and mobile satellite communication network. Server 100 connects Network Terminal 120 to the Telephone Set 140 that is associated with Telephone Number 1400 to communicate. This communication includes transmitting and receiving audio, video, text, and documents.

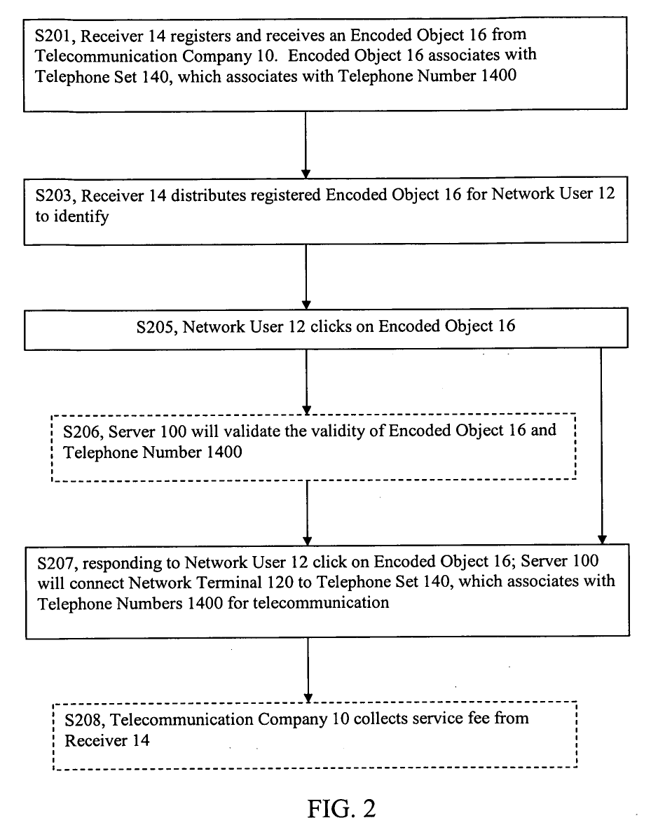

FIG. 2 is a flow diagram of an exemplary operation performed in accordance with one embodiment of the present invention.

Step S201, Receiver 14 registers with Telecommunication Company 10 and receives an Encoded Object 16, which links to Telephone Set 140, which associates with Telephone Number 1400. In a sense, Encoded Object 16 is an encoded Telephone Number 1400. Encoded Object 16 can be Uniform Resource Locator (URL). The Encoded Object 16 can be represented by icon, banner, logo, button, picture, marked text (such as underlined or shaded), and/or hyperlink. Encoded Object 16 can also be linked to multiple Telephone Sets 140 which associate with multiple Telephone Numbers 1400. In other words, Receiver 14 can use multiple telephone numbers.

Step S203, Receiver 14 distributes registered Encoded Object 16, including through Internet, for Network User 12 to identify. Encoded Object 16 can be placed on website, webpage, personal web-space, blog and/or within electronic document. Encoded Object 16 can be placed on short messages, multimedia messages, or instant messages. Encoded Object 16 can also be communicated with emails.

Step S205, Network User 12 click on the Encoded Object 16 whether it's represented by icon, banner, logo, button, picture, marked text, or hyperlink on any website, webpage, web-space, electronic document, within email, within short messages, within multimedia messages, or within instant messages.

Step S207, in respond to Network User 12 clicking on the Encoded Object 16, Server 100 will connect Network terminal 120 to Telephone Set 140 associated to a Telephone Numbers 1400 for voice communication. In actuality, when Server 100 receives the request from Network User 12 clicking on Encoded Object 16, Server 100 will make attempt to reach Receiver 14 by connecting Telephone Set 140 that is associated with Telephone Number 1400, then, send back the connection status. When connected, Network User 12 (e.g. in front of a personal computer) and Receiver 14 (e.g. using a mobile phone set) can communicate with each other by means of traditional interactive voice conversation. Telecommunication Company 100 assigns a specific number to be showed as Caller ID on the Telephone Set 140 for Receiver 14 to identify such a call. When connection to Telephone Set 14 failed for any reasons, the connection might be forwarded to another Telephone Set 14 appointed by Receiver 14. Receiver 14 can associate with multiple Telephone Sets 14 that are associated with multiple Telephone Numbers 1400. Server 100 could connect all numbers at once, or in the sequence defined by Receiver 14. Receiver 14 can define filtering preferences to filter incoming calls based on timeframes and geographic areas, including specific IP location of Network Terminal 120. These preferences can be updated and modified at any time.

Step S206, can be added in between S205 and S207. Server 100 will validate the validity of Encoded Object 16 and Telephone Number 1400. Server 100 will look up registered information, including profile and preference, within the database (not in the drawing) and validate the validity of Encoded Object 16, Telephone Number 1400, and calls. If any of them is invalid, then, a message will send to Network Terminal 120 to notify Network User 12 the status and terminate the connection process.

Step S208, Telecommunication Company 10 collects service fee from Receiver 14. Telecommunication Company 10 will collect service fees, which could be based on duration, frequency, volume, and/or flat fees. The collection process could be either pre-paid or post-paid. Telecommunication Company 10 does not collect fee from Network User 12.

The present invention allows Receiver 14 to provide convenient and effective way to be contacted by Network User 12. Receiver 14 will be responsible for the entire cost of this service. It's free for Network User 12 to access the service, which can promote and encourage Network User 12 to contact Receiver 14 by clicking on any Encoded Object 16 without hesitation. With existing telephone equipment and system, Receiver 14 can offer such service without any capital investment. Telephone Company also gains additional business and revenue. The present invention is a novel communicating method that offers gains to all parties and entities involved.

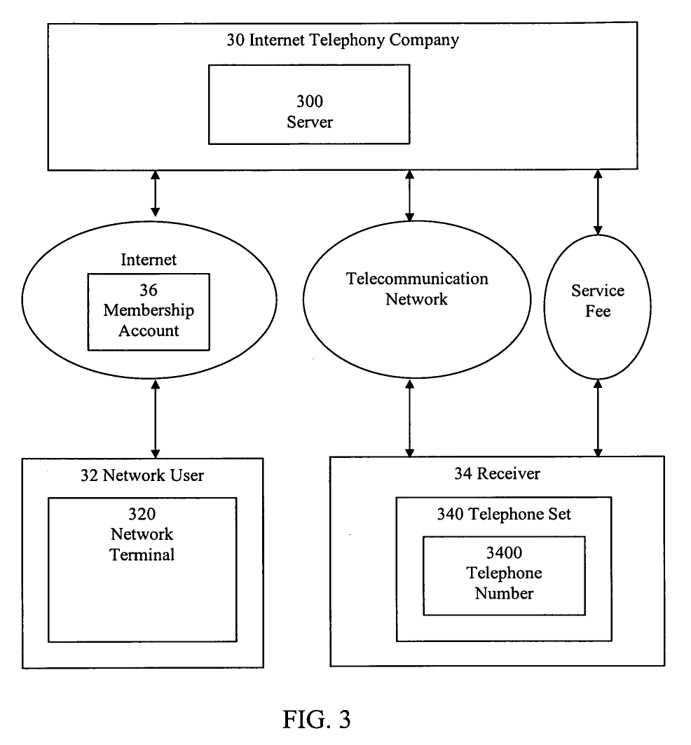

FIG. 3 is a high-level diagram showing parties and entities in accordance with one embodiment of the present invention.

Network User 32 use Network Terminal 320 to make call where as Network Terminal 320 refers to desktop computer, laptop computer, mobile and smart phone, PDA, or similar objects that has ability to access Internet with internal or external devices that can provide display, click, and voice functions. Display function refers to devices, such as monitors or handset screens, which can be browsed and display information. Click function refers to devices, such as keypad, mouse or touch panel, which allow Network User 12 to click on displayed information. Voice function refers to devices including speaker and microphone that collects and transmits voice.

Receiver 34 uses Telephone Set 340 that is associated with Telephone Number 3400 to answer a call. Telephone Set 340 refers to fixed, landline, mobile, cellular, cordless, or Internet (VoIP) telephone set.

Internet Telephony Company 30 owns Server 300. Internet Telephony Company 30 refers to companies that offer communication services and are regulated by the Federal Communication Committee or the like in its operating area. Server 300 and Network Terminal 320 are connected via Internet. The connection of a Server 300 and Telephone Set 340, which is associated with a Telephone Number 3400, is via a telecommunication network. Telecommunication network refers to public telecommunication networks, including public switched telephone network (PSTN), public land mobile network (PLMN), and mobile satellite communication network. Server 300 connects Network Terminal 320 to the Telephone Set 340 that is associated with Telephone Number 3400 to communicate. This communication includes transmitting and receiving audio, video, text, and documents.

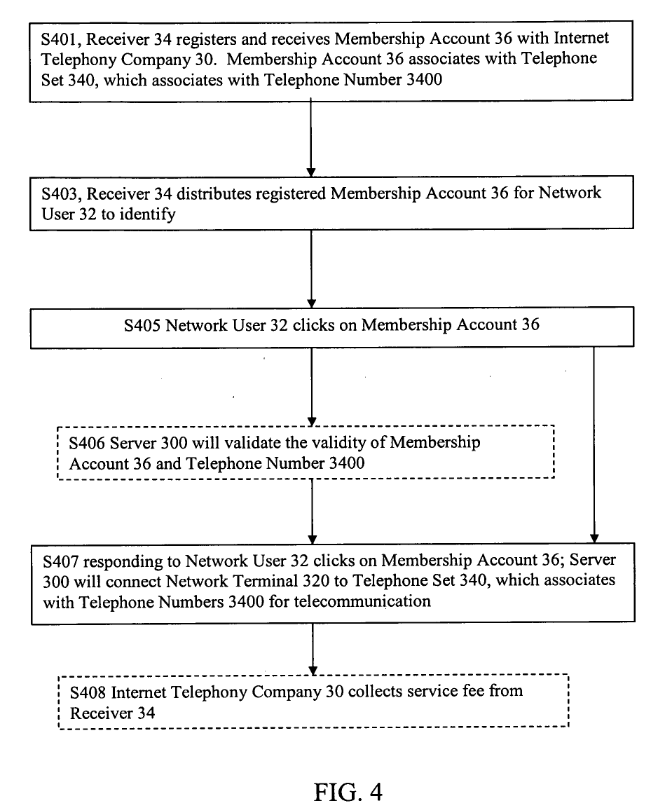

FIG. 4 is a flow diagram of an exemplary operation performed in accordance with one embodiment of the present invention.

Step S401, Receiver 34 registers with Internet Telephony Company 30 and receives a Membership Account 36, which links to Telephone Set 340, which associates with Telephone Number 3400. In a sense, Membership Account 36 is an encoded Telephone Number 3400. Membership Account 36 can be Uniform Resource Locator (URL). The Membership Account 36 can be represented by icon, banner, logo, button, picture, marked text (such as underlined or shaded), and/or hyperlink. Membership Account 36 can also be linked to multiple Telephone Sets 340 which associate with multiple Telephone Numbers 3400. In other words, Receiver 34 can use multiple telephone numbers.

Step S403, Receiver 34 distributes registered Membership Account 36, including through Internet, for Network User 32 to identify. Membership Account 36 can be placed on website, webpage, personal web-space, blog and/or within electronic document. Encoded Object 16 can be placed on instant messages. Membership Account 36 can also be communicated with emails.

Step S405, Network User 32 click on the Membership Account 36 whether it's represented by icon, banner, logo, button, picture, marked text, or hyperlink on any website, webpage, web-space, electronic document, within email, or within instant messages.

Step S407, in respond to Network User 32 clicking on the Membership Account 36, Server 300 will connect Network terminal 320 to Telephone Set 340 associated to a Telephone Numbers 3400 for voice communication. The Network terminal 320 may need to pre-install software from the Internet Telephony Company 30 in order for the Server 300 to detect the click or the call trigger on the Membership Account 36. In actuality, when Server 300 receives the request from Network User 32 clicking on Membership Account 36, Server 300 will make attempt to reach Receiver 34 by connecting Telephone Set 340 that is associated with Telephone Number 3400, then, send back the connection status. When connected, Network User 32 (e.g. in front of a personal computer) and Receiver 34 (e.g. using a mobile phone set) can communicate to each other by means of traditional interactive voice conversation. Internet Telephony Company 300 assigns a specific number to be showed as Caller ID on the Telephone Set 340 for Receiver 34 to identify such a call. When connection to Telephone Set 34 failed for any reasons, the connection might be forwarded to another Telephone Set 34 appointed by Receiver 34. Receiver 34 can associate with multiple Telephone Sets 34 that are associated with multiple Telephone Numbers 3400. Server 300 could connect all numbers at once, or in the sequence defined by Receiver 34. Receiver 34 can define filtering preferences to filter incoming calls based on timeframes and geographic areas, including specific IP location of Network Terminal 320. These preferences can be updated and modified at any time.

Step S406, can be added in between S405 and S407. Server 300 will validate the validity of Membership Account 36 and Telephone Number 3400. Server 300 will look up registered information, including profile and preference, within the database (not in the drawing) and validate the validity of Membership Account 36, Telephone Number 3400, and calls. If any of them is invalid, then, a message will send to Network Terminal 320 to notify Network User 32 the status and terminate the connection process.

Step S408, Internet Telephony Company 30 collects service fee from Receiver 34. Internet Telephony Company 30 will collect service fees, which could be based on duration, frequency, volume, and/or flat fees. The collection process could be either pre-paid or post-paid. Internet Telephony Company 30 does not collect fee from Network User 32.

The present invention allows Receiver 34 to provide convenient and effective way to be contacted by Network User 32. Receiver 34 will be responsible for the entire cost associate to this service. It's free for Network User 32 to access the service, which can promote and encourage Network User 32 to contact Receiver 34 by clicking on any Membership Account 36 without hesitation. With existing telephone equipment and system, Receiver 34 can offer such service without any capital investment. Telephone Company also gains additional business and revenue. The present invention is a novel communicating method that offers gains to all parties and entities involved.

While various exemplary embodiments of the present invention are described herein, it should be noted that the present invention may be embodied in other specific forms, including various modifications and improvements, without departing from the spirit and scope of the present invention. Thus, the described embodiments are to be considered in all respects only as illustrative and not restrictive.

What is claimed is:

1. A method for communicating in a communication system, the communication system comprising a network terminal of a network user, a server of a telecommunication company, and a telephone of a receiver, the method comprises the steps of:
(A) The receiver registering an encoded object from the telecommunication company, the encoded object is associated with a telephone number;
(B) The receiver distributing the encoded object for the network user to identify;
(C) The network user clicking on the encoded object;
(D) In response to the network user's clicking, the server connecting the network terminal to the telephone which uses the telephone number for a communication connection; and
(E) The telecommunication company collecting service fees from the receiver.

2. The method of claim 1, wherein the telecommunication company does not collect any fees from the network user.

3. The method of claim 1, wherein between step (C) and (D), further comprising: (F) the server validating the validity of the encoded object and the telephone number.

4. The method of claim 3, wherein when step (F) validity check failed, then, a message will be sent to the network terminal to notify the network user the status and terminate the connection process.

5. The method of claim 1, wherein step (D) if connection of telephone set failed, the connection might be forwarded to another telephone set appointed by the receiver.

6. The method of claim 1, wherein step (D) Caller ID shown on telephone set is a specific number assigned by the telecommunication company.

7. The method of claim 1, wherein the encoded object can also be linked to multiple telephone sets that are associated with multiple telephone numbers and the server could connect all numbers at once, or in the sequence defined by the receiver.

8. The method of claim 1, wherein the encoded object includes Uniform Resource Locator (URL).

9. The method of claim 1, wherein the encoded object is represented by icon, banner, logo, button, pictures, marked text, or hyperlink.

10. The method of claim 1, wherein the encoded object appears in webpages, emails, electronic documents, short messages, multimedia messages, or instant messages.

11. The method of claim 1, wherein the network terminal has the ability to access Internet with internal and/or external devices that provide display, click, and voice functions.

12. The method of claim 1, wherein the communication includes transmitting and receiving text, voice, picture, video, and documents.

13. The method of claim 1, wherein the receiver can define, update and modify filtering preferences including specific timeframes, geographic areas, and specific IP locations to filter incoming calls.

14. The method of claim 1, wherein the network terminal and the receiver's telephone can be desktop computers, notebooks, fixed telephone handsets, or mobile telephone handsets.

15. A method for communicating in a communication system, the communication system comprising a network terminal of a network user, a server of an Internet telephony company, and a telephone of a receiver, the method comprises the steps of:
(A) The receiver registering a membership account from the Internet telephony company, the membership account is associated with a telephone number;
(B) The receiver distributing the membership account for the network user to identify;
(C) The network user triggering the membership account to initiate a call;
(D) In response to the network user's triggering, the server connecting the network terminal to the telephone which uses the telephone number for a communication connection; and
(E) The Internet telephony company collecting service fees from the receiver.

16. The method of claim 15, wherein the Internet telephony company does not collect any fees from the network user.

17. The method of claim 15, wherein between step (C) and (D), further comprising: (F) the server validating the validity of the membership account and the telephone number.

18. The method of claim 17, wherein when step (F) validity check failed, then, a message will be sent to the network terminal to notify the network user the status and terminate the connection process.

19. The method of claim 15, wherein step (D) if connection of telephone set failed, the connection might be forwarded to another telephone set appointed by receiver.

20. The method of claim 15, wherein step (D) Caller ID shown on telephone set is a specific number assigned by Internet telephony company.

21. The method of claim 15, wherein the membership account can also be linked to multiple telephone sets that are associated with multiple telephone numbers and the server could connect all numbers at once, or in the sequence defined by receiver.

22. The method of claim 15, wherein the membership account is represented by icon, banner, logo, button, pictures, marked text, or hyperlink.

23. The method of claim 15, wherein the encoded object appears in webpages, emails, electronic documents, or instant messages.

24. The method of claim 15, wherein the network terminal has the ability to access Internet with internal and/or external devices that provide display, click, and voice functions.

25. The method of claim 15, wherein the communication includes transmitting and receiving text, voice, picture, video, and documents.

26. The method of claim 15, wherein the receiver can define, update and modify filtering preferences including specific timeframes, geographic areas, and specific IP locations to filter incoming calls.

27. The method of claim 15, wherein the network terminal and the receiver's telephone can be desktop computers, notebooks, fixed telephone handsets, or mobile telephone handsets.
